(19) United States
(12) Patent Application Publication
(10) Pub. No.: US 2025/0258699 A1
(43) Pub. Date: Aug. 14, 2025

(54) DYNAMICALLY BALANCING JOB QUEUES

(71) Applicant: SAP SE, Walldorf (DE)

(72) Inventor: Tobias Scheuer, Baden Württemberg (DE)

(21) Appl. No.: 18/436,441

(22) Filed: Feb. 8, 2024

(51) Int. Cl. G06F 16/2455; G06F 9/48; G06F 11/34

(52) U.S. Cl. CPC G06F 9/4831; G06F 9/4887; G06F 11/3433; G06F 2209/484

(57) ABSTRACT

Techniques for dynamically balancing job queues, such as the queues that are used by databases for executing query jobs, are provided. In certain embodiments, this dynamic balancing can be done in a manner that ensures short-running jobs (i.e., jobs that take a short time to execute) are given a similar proportion of compute time as longer-running jobs (i.e., jobs that take a longer time to execute), while also preventing the longer-running jobs from starving, or in other words being delayed for excessively long periods of time.

### BACKGROUND

In modern databases, queries and other tasks are often processed as jobs that are executed by worker threads. For example, when a query is received at a database, a job for the query (i.e., query job) is typically placed in a queue of waiting query jobs. When a worker thread associated with that queue becomes available, the highest priority query job in the queue is removed and passed to the worker thread for execution.

### BRIEF DESCRIPTION OF THE DRAWINGS

FIG. 1 depicts an example environment according to certain embodiments.

FIG. 2 depicts a version of the environment of FIG. 1 that implements the techniques of the present disclosure according to certain embodiments.

FIG. 3 depicts a dynamic job queue balancing workflow according to certain embodiments.

FIG. 4 depicts an example computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to techniques for dynamically balancing job queues, such as the queues that are used by databases for executing query jobs. In certain embodiments, this dynamic balancing can be done in a manner that ensures short-running jobs (i.e., jobs that take a short time to execute) are given a similar proportion of compute time as longer-running jobs (i.e., jobs that take a longer time to execute), while also preventing the longer-running jobs from starving, or in other words being delayed for excessively long periods of time.

### 1. Example Environment and Solution Overview

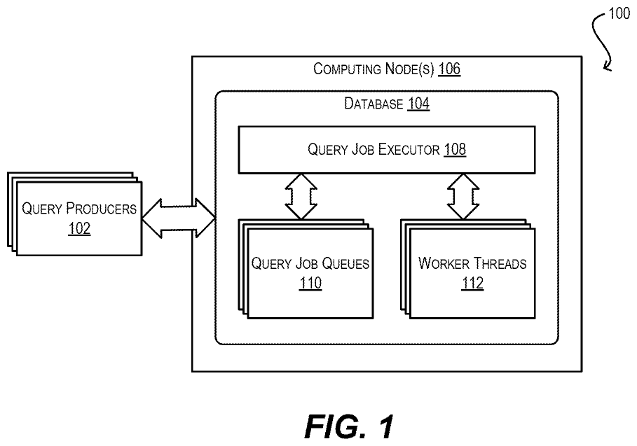

FIG. 1 depicts an example environment 100 in which the techniques of the present disclosure may be implemented. As shown, example environment 100 includes a set of query producers 102 that are communicatively coupled with a database 104 running on one or more computing nodes 106. Database 104 may be, for example, a relational database, a non-relational database, a hybrid relational/non-relational database, or any other type of database known in the art. In certain embodiments, database 104 may be an in-memory database that relies at least partially on volatile memory (e.g., RAM) for data storage, such as SAP HANA.

Database 104 comprises, among other things, a query job executor 108 that is communicatively coupled with a set of query job queues 110 and a set of worker threads 112. Each query job queue is associated with at least one worker thread. In some embodiments, query job queues 110 and/or worker threads 112 may be distributed across the one or more computing nodes 106 of database 104 such that each computing node maintains and/or runs a disjoint subset of these queues and/or worker threads.

In accordance with the present disclosure, query job executor 108 performs at least two functions: adding query jobs to query job queues 110 and removing query jobs from query job queues 110 for execution by worker threads 112. With respect to the first function, query job executor 108 receives database queries from the various query producers 102, which can be understood as applications that interact with database 104. Although query producers 102 are shown as being external to database 104, in some embodiments one or more of these query producers may be internal to the database. For each received query, query job executor 108 creates a query job (i.e., an action to be taken by database 104 for running the query), computes a priority for the query job, and inserts the query job with its computed priority into one of the query job queues.

Typically, query job executor 108 will compute this priority based on a “base number” and a timestamp, where the base number is a value that is assigned to the type of the query job and the timestamp is the time at which the query was received. For example, in one set of embodiments query job executor 108 can compute the priority as the query job's base number minus the timestamp, which means that given two query jobs with the same base number, the query job that is received earlier (and thus has a lower timestamp) will have the higher priority.

With respect to the second function noted above, when a worker thread 112 associated with a query job queue 110 becomes available (or in other words, becomes free to execute a query job), query job executor 108 identifies the highest priority query job in that queue. Job query executor 108 then removes the identified query job from the queue and passes it to the available worker thread for execution.

In many cases, query producers 102 will generate a mix of short-running queries (i.e., queries that take a relatively short time to execute, such as less than 10 milliseconds (ms)) and longer-running queries (i.e., queries that take a longer time to execute than the short-running queries, such as 30 ms or more), resulting in both short-running query jobs and longer-running query jobs in the query job queues of database 104. Examples of short-running queries are those that pertain to online transaction processing (OLTP) work and examples of longer-running queries are those that pertain to online analytical processing (OLAP) work. Short-running queries/query jobs are hereinafter referred to as “short” queries/query jobs and longer-running queries/query jobs are hereinafter referred to as “normal” queries/query jobs.

In these cases, if query job executor 108 used the same base number for computing the priorities of short and normal query jobs, the jobs would simply be executed in the order they are received. However, because normal query jobs take longer to execute than short query jobs, this approach can cause the normal jobs to consume a majority of the compute time of database 104 (within a certain time window), which is generally undesirable. For example, Table 1 below presents an example scenario in which a number of short and normal queries are received by query job executor 108 over a window spanning time steps 10 to 70 (in ms), resulting in the creation of corresponding query jobs in a query job queue Q1 and the execution of those jobs by a worker thread W1. In this scenario, it is assumed that the execution time for each short query job is 10 ms, the execution time for each normal query job is 30 ms, and the base number for both short and normal query jobs is the same (zero). In other words, there is no delta, or offset, between the short query job base number and the normal query job base number. Further, the name of each query job in queue Q1 indicates the type of the job (S for short and N for normal) and its computed priority. For example, a query job with the name “S-10” is a short query job with a priority of −10 and a query job with the name “N10” is a normal query job with a priority of 10.

TABLE 1
(Scenario with no base offset)

| | | Content of query | Operations |
|---|---|---|---|
| Time | Queries received | job queue Q1 | performed |
| 10 ms | 2 normal queries | N-10, N-10, S-10 | Query job executor |
| | (resulting in jobs | | removes N-10 from |
| | N-10 and N-10) | | Q1 and passes it to |
| | 1 short query | | worker thread W1 |
| | (resulting in job | | for execution |
| | S-10) | | |
| 20 ms | 1 short query | N-10, S-10, S-20 | None (W1 continues |
| | (resulting in job | | executing N-10) |
| | S-20) | | |
| 30 ms | 1 short query | N-10, S-10, S-20, | None (W1 continues |
| | (resulting in job | S-30 | executing N-10) |
| | S-30) | | |
| 40 ms | 1 short query | N-10, S-10, S-20, | Query job executor |
| | (resulting in job | S-30, S-40 | removes N-10 from |
| | S-40) | | Q1 and passes it to |
| | | | worker thread W1 |
| | | | for execution |
| 50 ms | None | S-10, S-20, S-30, | None (W1 continues |
| | | S-40 | executing N-10) |
| 60 ms | None | S-10, S-20, S-30, | None (W1 continues |
| | | S-40 | executing N-10) |
| 70 ms | 1 normal query | S-10, S-20, S-30, | Query job executor |
| | (resulting in job | S-40, N-70 | removes S-10 from |
| | N-70) | | Q1 and passes it to |
| | | | worker thread W1 |
| | | | for execution |

As can be seen in Table 1, worker thread W1 spends the majority of its time over the window of 10 to 70 ms executing normal query jobs. This is undesirable because the database actually receives more short query jobs than normal query jobs over this interval (four short jobs vs. three normal jobs).

It is possible for job query executor 108 to overcome the foregoing problem by statically assigning a larger base number to short query jobs than normal query jobs, such that there is a positive base offset. For example, Table 2 presents an example scenario that is similar to the scenario of Table 1, with the main difference being that short query jobs are assigned a base number of 30 ms and normal query jobs are assigned a base number of 0 (which means there is a base offset of 30).

TABLE 2
(Scenario with base offset of 30)

| | | Content of query | Operations |
|---|---|---|---|
| Time | Queries received | job queue Q1 | performed |
| 10 ms | 2 normal queries | N-10, N-10, S20 | Query job executor |
| | (resulting in jobs | | removes S20 from |
| | N-10 and N-10) | | Q1 and passes it to |
| | 1 normal query | | worker thread W1 |
| | (resulting in job | | for execution |
| | N-10) | | |
| | 1 short query | | |
| | (resulting in job | | |
| | S20) | | |
| 20 ms | 1 short query | N-10, N-10, S10 | Query job executor |
| | (resulting in job | | removes S10 from |
| | S10) | | Q1 and passes it to |
| | | | worker thread W1 |
| | | | for execution |
| 30 ms | 1 short query | N10, N-10, S0 | Query job executor |
| | (resulting in job | | removes S0 from Q1 |
| | S0) | | and passes it to |
| | | | worker thread W1 |
| | | | for execution |
| 40 ms | 1 short query | N-10, N-10, S-10 | Query job executor |
| | (resulting in job | | removes N-10 from |
| | S-10) | | Q1 and passes it to |
| | | | worker thread W1 |
| | | | for execution |
| 50 ms | None | N-10, S-10 | None (W1 continues |
| | | | executing N-10) |
| 60 ms | None | N-10, S-10 | None (W1 continues |
| | | | executing N-10) |
| 70 ms | 1 normal query | N-10, S-10, N-70 | Query job executor |
| | (resulting in job | | removes N-10 from |
| | N-70) | | Q1 and passes it to |
| | | | worker thread W1 |
| | | | for execution |

As can be seen in Table 2, with a base offset of 30 in place, worker thread W1 spends roughly the same amount of time executing short and normal query jobs over the time window of 10 to 70 ms. This advantageously results in a more equitable distribution of database compute time for these two query job types when compared to the scenario of Table 1 (where there is no base offset).

One issue with using a static, larger base number for short query jobs (and thus, a static positive base offset) as explained above is that it can cause normal query jobs to starve in some situations. Starvation in this context means that the normal query jobs are delayed for an excessively long period of time. For example, if the configured base number for short query jobs gives such jobs a priority advantage of one hour over normal query jobs (such that all short query jobs received within one hour after a normal query job are prioritized/executed before that normal query job), this means all normal query jobs in a given queue will be delayed by at least one hour, as long as there are small query jobs continuously coming into the queue.

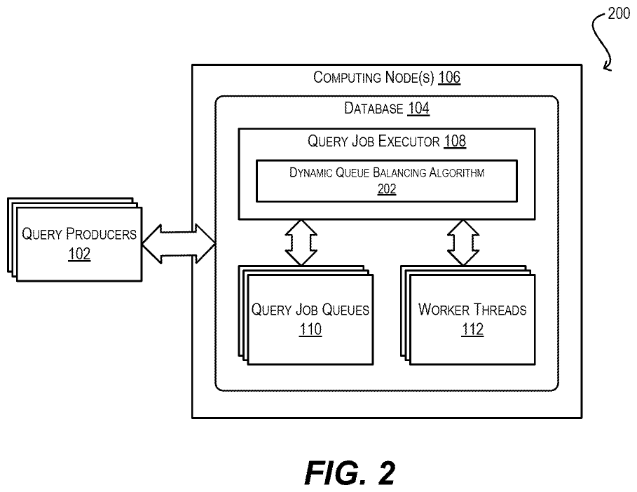

To address this problem, FIG. 2 depicts a modified version 200 of environment 100 of FIG. 1 that includes a dynamic queue balancing algorithm 202 within query job executor 108 according to certain embodiments. Dynamic queue balancing algorithm 202 may be implemented in software, in hardware, or via a combination thereof.

As explained in further detail below, dynamic queue balancing algorithm 202 can enable query job executor 108 to adaptively adjust the base number that is assigned to short query jobs (or in other words, adaptively adjust the base offset) based on the cumulative execution times of short query jobs and normal query jobs that are completed by worker threads over a sliding time window. For example, if query job executor 108 determines that the cumulative execution time of completed short query jobs is greater than the cumulative execution time of completed normal query jobs by some threshold amount over the most recent time window (which means that the amount of compute time consumed by short query jobs is currently larger than desired), query job executor 108 can adjust the base offset in a manner that decreases the priorities of short query jobs relative to normal query jobs.

Conversely, if query job executor 108 determines that the cumulative execution time of completed short query jobs is less than the cumulative execution of completed normal query jobs by another threshold amount over the most recent time window (which means that the amount of compute time consumed by short query jobs is currently less than desired), query job executor 108 can adjust the base offset in a manner that increase the priorities of short query jobs relative to normal query jobs. Thus, with this solution, query job executor 108 can advantageously balance the two competing objectives of (1) keeping the amount of compute time consumed by short and normal query jobs relatively even (e.g., via a positive base offset) and (2) preventing starvation of the normal query jobs (e.g., by preventing the base offset from becoming too large in view of runtime conditions).

It should be appreciated that FIGS. 1 and 2 and the foregoing high-level solution description are illustrative and not intended limit embodiments of the present disclosure. For example, although the figures and description present the solution in the context of dynamically balancing query job queues 110 of database 104, the concepts described herein may be applied to dynamically balance any types of job queues that are used by a database or any other data processing system. Accordingly, all references to “query jobs” and “query job queues” may be replaced with the more generic terms “jobs” and job queues.”

Further, although the foregoing description assumes that there are exactly two types of query jobs in database 104 (i.e., short query jobs and normal query jobs), the solution of the present disclosure may be generalized to support multiple different query job types. For example, if database 104 makes use of a first query job type J1 with a first base number B1, a second query job type J2 with a second base number B2, and a third query job type J3 with a third base number B3, dynamic queue balancing algorithm 202 can enable query job executor 108 to adaptively adjust the base numbers of any combination of job types J1, J2, and J3 to ensure that the query jobs of these types are given an equitable proportion of compute time in the database.

Yet further, although FIGS. 1 and 2 depict a particular arrangement of components within database 104, other arrangements are possible. For example, the functionality attributed to a particular component may be split into multiple components, components may be combined, and so on. One of ordinary skill in the art will recognize other variations, modifications, and alternatives.

### 2. Dynamic Queue Balancing Workflow

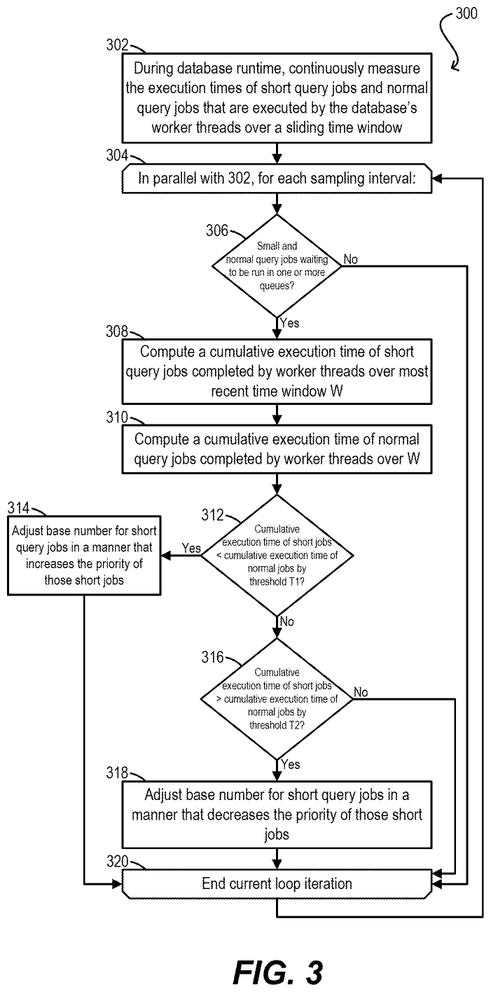

FIG. 3 depicts a workflow 300 that may be performed by query job executor 108 of FIG. 2 via its dynamic queue balancing algorithm 202 for dynamically adjusting the base number that it uses to compute the priorities of short query jobs according to certain embodiments. In cases where the query job queues and worker threads of database 104 are distributed across computing nodes 106, query job executor 108 may perform an instance of this workflow with respect to the query job queues of each computing node.

Workflow 300 assumes that the base number for short query jobs is initialized to be the same as (or relatively close to) the base number for normal query jobs. In other words, the base offset is assumed to be initialized to zero (or close to zero).

Starting with step 302, query job executor 108 can continuously measure, during the runtime of database 104, the execution times of short query jobs and normal query jobs that are executed by worker threads 112 over a sliding time window (e.g., the last sixty seconds). In a particular embodiment, this step can be performed by a background process of query job executor 108.

In parallel with step 302, query job executor 108 can enter a processing loop 304 on a periodic basis (e.g., once every 500 milliseconds), referred to the sampling interval. Within this processing loop, query job executor 108 can first check whether there are both small and normal query jobs waiting to run in at least one query job queue (or in other words, whether at least query job queue contains at least one small query job and at least one normal query job) (step 306). If the answer is no, query job executor 108 can proceed to the end of the current loop iteration.

However, if the answer at step 306 is yes, query job executor 108 can compute the cumulative execution time of short query jobs completed by the database's worker threads over the most recent time window W (step 308) and the cumulative execution time of normal query jobs completed by the database's worker threads over W (step 310). Query job executor 108 can then determine whether the cumulative execution time of short query jobs as computed at step 308 is less than the cumulative execution time of normal query jobs as computed at step 310 by a threshold amount T1 (step 312).

If the answer at step 312 is yes, query job executor 108 can conclude that short query jobs are not being given sufficient compute time. Accordingly, query job executor 108 can adjust the base number it uses to compute the priorities of short query jobs (or in the words, the base offset) in a manner that increases the priorities of those short jobs (step 314). For example, if query job executor 108 computes query job priority as the base number minus the timestamp, query job executor 108 can increase the base number of short query jobs by some percentage amount (e.g., 10%, 20%, etc.). The exact amount of this increase can depend on various factors, such as the typical execution times of the short and normal query jobs and the length of the sampling interval.

In one set of embodiments, once it has performed this adjustment, query job executor 108 may change the priorities of all currently queued short query jobs in accordance with the new base number (not shown). In other embodiments, query job executor 108 may leave the currently queued short query jobs as-is and use the adjusted base number to compute priorities for short query jobs that are received and queued from that point forward.

Alternatively, if the answer at step 312 is no, query job executor 108 can further determine whether the cumulative execution time of short query jobs as computed at step 308 is greater than the cumulative execution time of normal query jobs as computed at step 310 by another threshold amount T2 (step 316). In certain embodiments, threshold amount T2 may be equal to threshold amount T1 used at step 312. In other embodiments, T1 and T2 may be different.

If the answer at step 316 is no, query job executor 108 can proceed to the end of the current loop iteration. However, if the answer at step 316 is yes, query job executor 108 can conclude that normal query jobs are not being given sufficient compute time relative to the short query jobs. Accordingly, query job executor 108 can adjust the base number it uses to compute the priorities of short query jobs (or in the words, the base offset) in a manner that decreases the priorities of those short jobs (step 318). For example, if query job executor 108 computes query job priority as the base number minus the timestamp, query job executor 108 can decrease the base number of short query jobs by some percentage amount (e.g., 10%, 20%, etc.). The exact amount of this decrease can depend on various factors, such as the typical execution times of the short and normal query jobs and the length of the sampling interval.

As with the adjustment performed at step 314, query job executor 108 may change the priorities of all currently queued short query jobs in accordance with the adjusted base number determined at step 318 (not shown). In other embodiments, query job executor 108 may leave the currently queued short query jobs as-is and use the adjusted base number to compute priorities for short query jobs that are received and queued from that point forward.

Finally, query job executor 108 can reach the end of the current loop iteration (step 320) and return to step 304 to repeat the loop at the next sampling interval.

### 3. Example Computer System

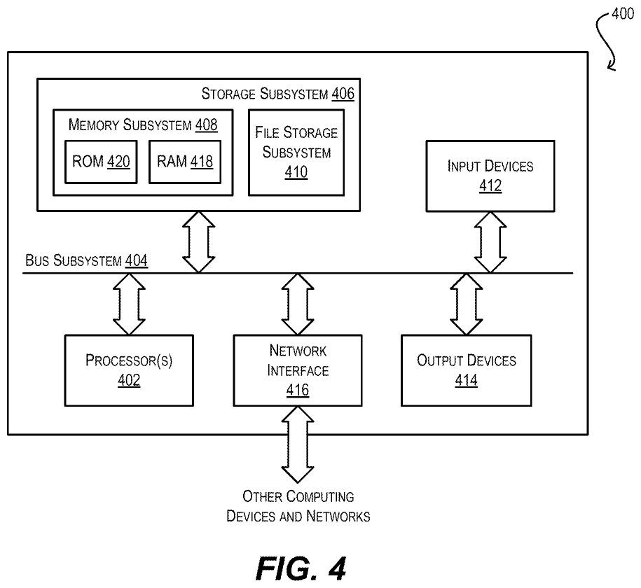

FIG. 4 is a simplified block diagram of an example computer system 400 according to certain embodiments. Computer system 400 (and/or equivalent systems/devices) may be used to run any of the software components described in the foregoing disclosure, including job query executor 108 and/or dynamic queue balancing algorithm 202 of FIG. 2. As shown in FIG. 4, computer system 400 includes one or more processors 402 that communicate with a number of peripheral devices via a bus subsystem 404. These peripheral devices include a storage subsystem 406 (comprising a memory subsystem 408 and a file storage subsystem 410), user interface input devices 412, user interface output devices 414, and a network interface subsystem 416.

Bus subsystem 404 can provide a mechanism for letting the various components and subsystems of computer system 400 communicate with each other as intended. Although bus subsystem 404 is shown schematically as a single bus, alternative embodiments of the bus subsystem can utilize multiple buses.

Network interface subsystem 416 can serve as an interface for communicating data between computer system 400 and other computer systems or networks. Embodiments of network interface subsystem 416 can include, e.g., an Ethernet module, a Wi-Fi and/or cellular connectivity module, and/or the like.

User interface input devices 412 can include a keyboard, pointing devices (e.g., mouse, trackball, touchpad, etc.), a touch-screen incorporated into a display, audio input devices (e.g., voice recognition systems, microphones, etc.), motion-based controllers, and other types of input devices. In general, use of the term “input device” is intended to include all possible types of devices and mechanisms for inputting information into computer system 400.

User interface output devices 414 can include a display subsystem and non-visual output devices such as audio output devices, etc. The display subsystem can be, e.g., a transparent or non-transparent display screen such as a liquid crystal display (LCD) or organic light-emitting diode (OLED) display that is capable of presenting 2D and/or 3D imagery. In general, use of the term “output device” is intended to include all possible types of devices and mechanisms for outputting information from computer system 400.

Storage subsystem 406 includes a memory subsystem 408 and a file/disk storage subsystem 410. Subsystems 408 and 410 represent non-transitory computer-readable storage media that can store program code and/or data which provide the functionality of embodiments of the present disclosure in a non-transitory state.

Memory subsystem 408 includes a number of memories including a main random access memory (RAM) 418 for storage of instructions and data during program execution and a read-only memory (ROM) 420 in which fixed instructions are stored. File storage subsystem 410 can provide persistent (i.e., non-volatile) storage for program and data files, and can include a magnetic or solid-state hard disk drive, an optical drive along with associated removable media (e.g., CD-ROM, DVD, Blu-Ray, etc.), a removable or non-removable flash memory-based drive, and/or other types of non-volatile storage media known in the art.

It should be appreciated that computer system 400 is illustrative and other configurations having more or fewer components than computer system 400 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

What is claimed is:

1. A method for dynamically balancing a query job queue in a database, the method comprising:
during runtime of the database, continuously measuring execution times of short query jobs and normal query jobs that are executed by the database, wherein the normal query jobs are query jobs that take longer to complete than the short query jobs, and wherein the short query jobs and the normal query jobs are queued for execution in the query job queue in accordance with a priority that is computed for each query job;
and on a periodic basis:
computing a first cumulative execution time of a set of the short query jobs that are completed within a recent time window;
computing a second cumulative execution time of a set of the normal query jobs that are completed within the recent time window;
upon determining that the first cumulative execution time is less than the second cumulative execution time by a first threshold, adjusting a first base number used for computing priorities for the short query jobs in a manner that increases the priorities; and
upon determining that the first cumulative execution time is greater than the second cumulative execution time by a second threshold, adjusting the first base number used for computing priorities for the short query jobs in a manner that decreases the priorities.

2. The method of claim 1 wherein a second base number is used for computing priorities for the normal query jobs, and wherein adjusting the first base number in a manner that increases the priorities for the short query jobs comprises increasing an offset between the first base number and the second base number.

3. The method of claim 1 wherein a second base number is used for computing priorities for the normal query jobs, and wherein adjusting the first base number in a manner the decreases the priorities of the short query jobs comprises decreasing an offset between the first base number and the second base number.

4. The method of claim 1 wherein the priority for each query job is computed as a base number minus a timestamp, the base number being a value that is associated with a type of the query job and the timestamp being a time at which a query for the query job was received.

5. The method of claim 4 wherein adjusting the first base number in a manner that increases the priorities for the short query jobs comprises increasing the first base number.

6. The method of claim 4 wherein adjusting the first base number in a manner that decreases the priorities for the short query jobs comprises decreasing the first base number.

7. The method of claim 1 wherein the first threshold and the second threshold are identical.

8. The method of claim 1 wherein the first threshold and the second threshold are different.

9. The method of claim 1 further comprising, upon adjusting the first base number in a manner that increases or decreases the priorities of the short query jobs:
recomputing priorities for all short query jobs currently queued in the query job queue.

10. The method of claim 1 wherein the method is performed by a query job executor of the database.

11. A computer system comprising:
a processor; and
a computer-readable medium having stored thereon instructions, that when executed by the processor, causes the processor to:
continuously measure execution times of jobs of a first type and jobs of a second type, wherein the jobs of the second type are jobs that take longer to complete than the jobs of the first type, and wherein the jobs of the first type and the jobs of the second type are queued for execution in a job queue in accordance with a priority that is computed for each job; and
on a periodic basis:
compute a first cumulative execution time of a set of the jobs of the first type that are completed within a recent time window;
compute a second cumulative execution time of a set of the jobs of the second type that are completed within the recent time window; and
upon determining that the first cumulative execution time is less than the second cumulative execution time by a first threshold, adjust a first value used for computing priorities for the jobs of the first type in a manner that increases the priorities.

12. The computer system of claim 11 wherein the instructions further cause the processor to:
upon determining that the first cumulative execution time is greater than the second cumulative execution time by a second threshold, adjust the first value used for computing priorities for the jobs of the first type in a manner that increases the priorities.

13. The computer system of claim 11 wherein the computer system implements a database and the job queue is a query job queue of the database.

14. The computer system of claim 13 wherein the jobs of the first type are short query jobs and the jobs of the second type are normal query jobs that take longer to complete than the short query jobs.

15. The computer system of claim 11 wherein the instructions further cause the processor to, prior to computing the first and second cumulative execution times:
check whether the job queue contains at least one job of the first type and at least one job of the second type.

16. The computer system of claim 11 wherein a second value is used for computing priorities for the jobs of the second type, and wherein adjusting the first value in a manner that increases the priorities for the jobs of the first type comprises increasing an offset between the first value and the second value.

17. The computer system of claim 11 wherein a second value is used for computing priorities for the jobs of the second type, and wherein adjusting the first value in a manner the decreases the priorities of the jobs of the first type comprises decreasing an offset between the first value and the second value.

18. A non-transitory computer-readable medium having stored thereon instructions executable by a computer system, the instructions causing the computer system to:
during runtime of the database, continuously measure execution times of short query jobs and normal query jobs that are executed by the database, wherein the normal query jobs are query jobs that take longer to complete than the short query jobs, and wherein the short query jobs and the normal query jobs are queued for execution in a query job queue in accordance with a priority that is computed for each query job;
and on a periodic basis:
compute a first cumulative execution time of a set of the short query jobs that are completed within a recent time window;
compute a second cumulative execution time of a set of the normal query jobs that are completed within the recent time window;
upon determining that the first cumulative execution time is less than the second cumulative execution time by a first threshold, adjust a first base number used for computing priorities for the short query jobs in a manner that increases the priorities; and
upon determining that the first cumulative execution time is greater than the second cumulative execution time by a second threshold, adjust the first base number used for computing priorities for the short query jobs in a manner that decreases the priorities.

19. The non-transitory computer-readable storage medium of claim 18 wherein a second base number is used for computing priorities for the normal query jobs, and wherein adjusting the first base number in a manner that increases the priorities for the short query jobs comprises increasing an offset between the first base number and the second base number.

20. The non-transitory computer-readable storage medium of claim 18 wherein a second base number is used for computing priorities for the normal query jobs, and wherein adjusting the first base number in a manner the decreases the priorities of the short query jobs comprises decreasing an offset between the first base number and the second base number.
